(19) United States
(12) Patent Application Publication
(10) Pub. No.: US 2011/0101049 A1
(43) Pub. Date: May 5, 2011

(54) Tricked out bumpers

(76) Inventor: Billy Ray Rivers, Highland, CA (US)

(21) Appl. No.: 12/925,640

(22) Filed: Oct. 26, 2010

Related U.S. Application Data
(60) Provisional application No. 61/280,309, filed on Nov. 2, 2009.

(51) Int. Cl. B62D 43/00

(52) U.S. Cl. 224/42.12

(57) ABSTRACT

A bumper-equipped spare-tire carrier to be mounted on the rear bumper of an automobile, the Tricked Out Bumpers provide carry-space for the spare tire in an elegant and stylish manner, and can be moved forward and back by remote control, appealing strongly to low-rider and other auto enthusiasts. Fabricated of the highest-quality components and available to fit the more popular sizes of tires, the Tricked Out Bumpers will find a wide and receptive market among America's auto owners and aficionados.

### CLAIM OF PRIORITY

This patent application claims priority under 35 USC 119(e)(1) from U.S. Provisional Patent Application Ser. No. 61/280,309 filed Nov. 2, 2009, of common inventorship herewith entitled, “Tricked Out Bumpers.”

### FIELD OF THE INVENTION

The present invention pertains to the field of automobile accessories, and more specifically to the field of automobile bumpers, and even more specifically to automobile bumpers configured to hold the spare tire of an automobile.

### BACKGROUND OF THE INVENTION

The prior art has put forth several designs for spare tire carriers for automobiles. Among these are:
U.S. Pat. Des. 170,317 to Wallace H. Hawkins describes an automobile ornament configured to hold a spare tire on the rear bumper of an automobile.
U.S. Pat. No. 3,827,521 to Emery H. Welsh describe a spare tire enclosure which is mounted in front of the radiator of a vehicle.
U.S. Pat. No. 4,485,945 to V. Scott Ankeny describes a vehicle spare tire carrier which is pivotally mounted to an automobile.

None of these prior art references describe the present invention.

### SUMMARY OF THE INVENTION

It is an object of the present invention to provide an improved spare tire carrier for mounting on the rear bumper of an automobile.

### BRIEF DESCRIPTION OF THE DRAWINGS

FIG. 1 is a perspective view of the rear end of an automobile showing the spare tire carrier of the instant invention in use.

FIG. 2 is a perspective view of the rear end of an automobile showing the spare tire carrier of the instant invention holding a spare tire with the upper portion open.

FIG. 3 is a perspective view of the rear end of an automobile showing the spare tire carrier of the instant invention with no spare tire.

FIG. 4 is an additional perspective view of the rear end of an automobile showing the spare tire carrier of the instant invention in use showing the control arm.

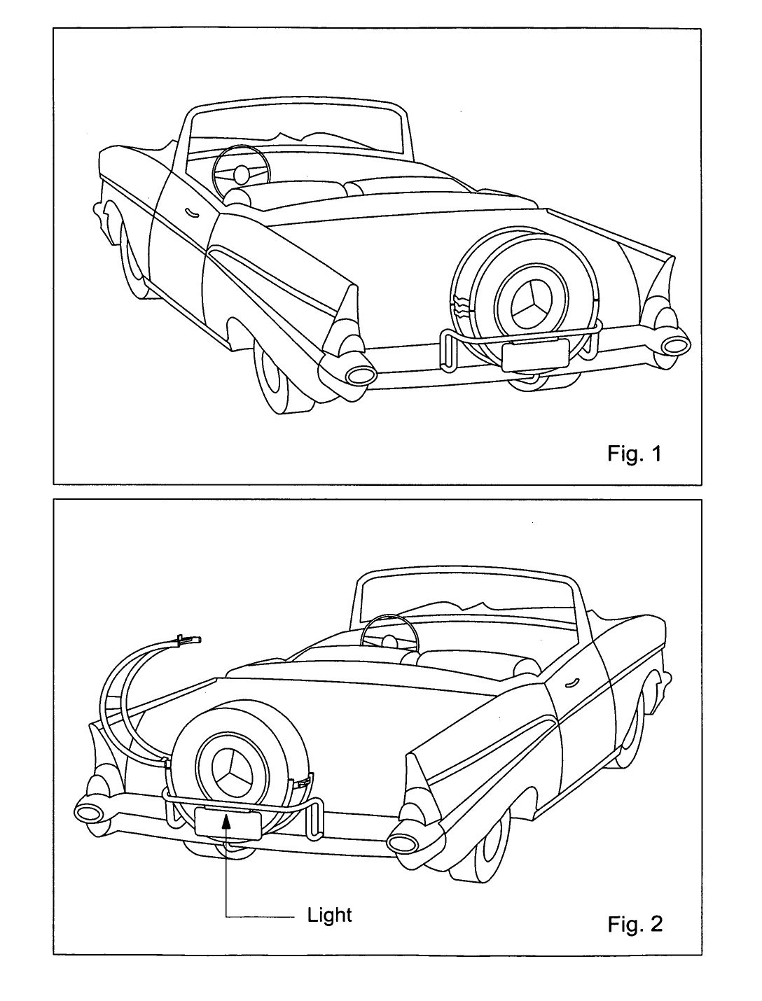

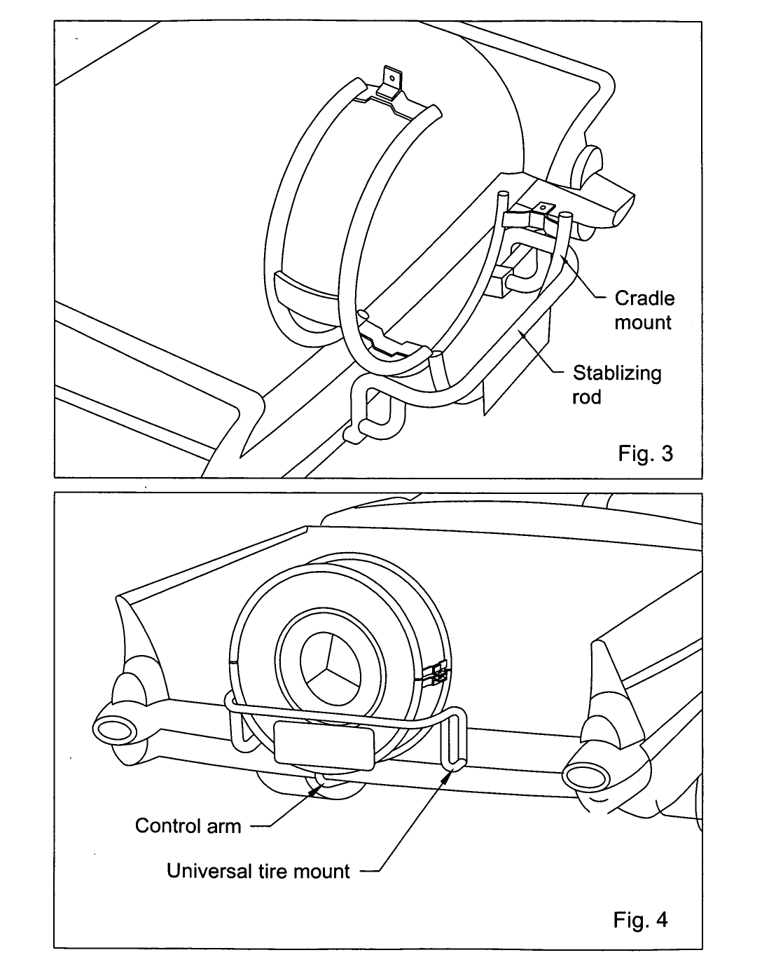

### DETAILED DESCRIPTION OF THE INVENTION

A car is not only our transportation but a sort of visible “garment” that we wear.” Its look, in a very real sense, is our look. We all want to look good, to make a good impression; and that is true whether we're driving a high-dollar, tricked-out “fly” ride, a low-rider that will jump up in the air, or not. Just as we choose our clothes on the basis of a personal style that reflects our personality, many of us customize our cars to express ourselves, to represent to the world that this is who we are and how we travel. To this end, we invest in rims and tires, custom paint-jobs, audio and video systems, and sophisticated lighting arrays. With each accessory, each accent, each feature that we add, our car becomes more unique, and more uniquely us.

The present invention, hereinafter referred to as Tricked Out Bumpers is a unique new way of tricking out a car, with the spare tire and rim. Recognizing the possibility of creating a unique new accessory for low-riders and other auto enthusiasts, the present invention was developed.

Simply stated, the Tricked Out Bumpers comprise a spare-tire carrier, mounted to the rear bumper of a vehicle, and equipped with a protective bumper of its own. The entire unit is equipped with an optional controller, through which the operator could “trick out” the bumper and tire-holder, moving it forward or backward with the flick of a switch. Manufactured by the Motor Vehicles Parts and Accessories industry, Standard Industrial Code 3714, the Tricked Out Bumpers are fabricated of a strong steel alloy. In one embodiment, the bumper is fabricated from 2-inch steel pipe, 3/16-inch steel plate, and ⅛-inch steel plate.

The Tricked Out Bumpers is mounted to a flat, 2-inch square steel universal mounting plate or bracket, which is welded or bolted onto the rear bumper of the automobile. To this mounting plate is fastened (again, by welds or bolts) a hinged, circular, tubular steel housing within which the spare tire and wheel will fit. The housing is fabricated of steel tubing, such that the tire and wheel are held within one circular tube on the inner surface (closest to the car's bumper) and one circular tube at the outer surface. The two circular members, which encompass the circumference of the tire, are joined by welded steel bands on the right and left midpoints. One of these bands will feature a hinge, such that the tubular frame may be opened, lifted away from the tire; the other will contain a lock so that, when closed, the tire-holder may be secured against theft of spare tire and rim.

From the two midpoints on each side of the tire-holding assembly, another section of rolled steel tubing extends down and to the rear, and this steel tubing is bent to form a bumper extension, literally a second bumper, which protects the tire-holding frame.

The entire device can be equipped with an optional, hydraulic or pneumatic pump assembly. When installed, the pump is controlled from a switch installed in the driver's dashboard or door; when activated, the pump lifts and lowers (or moves forward and backward) the “tricked out” bumper and tire-holder in a most impressive manner. The Tricked Out Bumpers can be manufactured to fit a variety of tire sizes, and can be chromed, powder-coated, or painted in a variety of eye-catching colors.

The Tricked Out Bumpers, an elegant device for carrying and displaying a spare tire and rim above the rear bumper of a show car, present a number of singular and distinct benefits and advantages. Foremost, the Tricked Out Bumpers become a highly visible, exceptionally fly accessory to a low-rider or otherwise tricked-out car. Hearkening back to the elegant automobile designs from the 1930's and 40's, the Tricked Out Bumpers lend an aura of class and refinement to the vehicle on which it was installed and allows the owner to display not the usual four rims, but five, thereby outclassing the competition in style and elegance. Further, because low-rider automobiles typically retain little room for a conventional spare tire because this space is given up in favor of multiple batteries, pumps, and the other apparatus that these tricked-out rides require, the Tricked Out Bumpers actually serves a purpose of common necessity and safety: a place to carry a spare tire and rim.

Additionally, the Tricked Out Bumpers are available in a basic and deluxe edition, the deluxe model including a pump assembly for making the bumper and tire-holder move, a favorite motif among low-rider enthusiasts.

The Tricked Out Bumpers provide: 1) storage, locking storage, for a spare tire and rim; 2) an eye-catching accessory of style, class, and elegance; 3) a second rear bumper for added protection from rear-end impacts; and 4) if equipped with the optional pump and controller, a jumpin' new must-have accessory for the low-rider enthusiast.

A bumper-equipped spare-tire carrier to be mounted on the rear bumper of an automobile, the Tricked Out Bumpers provide carry-space for the spare tire in an elegant and stylish manner, and can be moved forward and back by remote control, appealing strongly to low-rider and other auto enthusiasts. Fabricated of the highest-quality components and available to fit the more popular sizes of tires, the Tricked Out Bumpers will find a wide and receptive market among America's auto owners and aficionados.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A spare tire carrier for an automobile mountable to the rear end of the automobile, comprising a spare-tire carrier mounted to the rear bumper of a vehicle.

2. The spare tire carrier of claim 1 further comprising an optional controller for moving the spare tire carrier forward or backward.

3. The spare tire carrier of claim 2 further comprising a switch for activating the controller for moving the spare tire carrier.

4. The spare tire carrier of claim 2 comprising a steel alloy.

5. The spare tire carrier of claim 4 wherein the bumper is fabricated from 2 inch diameter steel pipe, 3/16 inch thick steel plate, and ⅛ inch thick steel plate.

6. The spare tire carrier of claim 4 wherein the carrier is mounted to a flat, 2 inch square steel universal mounting plate, said mounting plate is welded or bolted onto the rear bumper of the automobile.

7. The spare tire carrier of claim 6 wherein to this mounting plate is fastened a hinged, circular, tubular steel housing within which the spare tire and wheel will fit.

8. The spare tire carrier of claim 7 wherein the carrier is fabricated of steel tubing, and configured into two parallel circular members, and wherein the two circular members encompass the circumference of the tire, and are joined by welded steel bands on the right and left midpoints of the circular members, and wherein one of the bands comprise a hinge, to open the tubular frame and lifted away from the tire; the other circular member comprises a lock to secure the tire in the tire carrier when closed.

9. The spare tire carrier of claim 7 wherein an additional section of rolled steel tubing extends down and to the rear wherein this steel tubing is bent to form a bumper extension, wherein the additional section is attached at the midpoints of the circular members.

10. The spare tire carrier of claim 3 further comprising a hydraulic or pneumatic pump assembly, wherein the pump is controlled from a switch installed in the driver's dashboard or door; and when activated, the pump lifts and lowers or moves forward and backward spare tire carrier.

11. The spare tire carrier of claim 1 manufactured to fit a variety of tire sizes, chromed, powder-coated, or painted.
